(19) United States
(12) Patent Application Publication
(10) Pub. No.: US 2011/0036208 A1
(43) Pub. Date: Feb. 17, 2011

(54) Planetary gear-driven magnification driving tool

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 12/461,537

(22) Filed: Aug. 14, 2009

(51) Int. Cl. B25B 17/00

(52) U.S. Cl. 81/57

(57) ABSTRACT

The present invention of a planetary gear-driven magnification driving tool relies on randomly attachable and removable planetary gear-driven magnification driving tools to lock, adjust, and disassemble applied mechanism with screw structure such as screw locking device, screw adjusting device, and individual screw and nut set that do not need the installation of outer ring gear and planetary gear while reducing the installation cost for over a pair of such mechanisms.

### BACKGROUND OF THE INVENTION

(a) Field of the Invention

The traditional gear-driven screw and nut set installs the outer ring gear on the nut, and installs the planetary gear on the bolt. The screw and nut set must be installed in the planetary gear set structure one by one which entails a relatively high production cost. The present invention of a planetary gear-driven magnification driving tool relies on randomly attachable and removable planetary gear-driven magnification driving tools to lock, adjust, and disassemble applied mechanism with screw structure such as screw locking device, screw adjusting device, and individual screw and nut set that do not need the installation of outer ring gear and planetary gear while reducing the installation cost for over a pair of such mechanisms.

(b) Description of the Prior Art

The planetary gear-driven screw and nut set installs the outer ring gear on the nut, and installs the planetary gear on the bolt. The screw and nut set must be installed in the planetary gear set structure one by one. Each screw and nut set must all be installed on the gear set which entails a relatively high production cost.

### SUMMARY OF THE INVENTION

The present invention of a planetary gear-driven magnification driving tool relies on randomly attachable and removable planetary gear-driven magnification driving tools to lock, adjust, and disassemble applied mechanism with screw structure such as screw locking device, screw adjusting device, and individual screw and nut set that do not need the installation of outer ring gear and planetary gear while reducing the installation cost for over a pair of such mechanisms.

### BRIEF DESCRIPTION OF THE DRAWINGS

FIG. 1 is a top cross-sectional view of the present invention

FIG. 2 is a cross-sectional view of the present invention

FIG. 3 is a bottom view of the present invention

FIG. 4 is a dimensional exploded view of the present invention

FIG. 5 is a dimensional view of the polyhedral cylinder (141′) replacing the inner polygonal hole (141) in FIG. 1 to FIG. 4 of the present invention

FIG. 6 is a sectional view of FIG. 5

FIG. 7 is a dimensional view of the inner polygonal hole (124′) replacing the polyhedral cylinder (124) in FIG. 1 to FIG. 4

FIG. 8 is a cross-sectional view of the FIG. 7

FIG. 9 is a functional view of the driven stud (140) being welded on the structure (200)

FIG. 10 is a functional view of the stud (140) being screwed on the screw hole of the structure (200) of the present invention

FIG. 11 is a functional view of the present invention showing the stud 140 penetrating the structure with the other end installed with a nut

FIG. 12 is a functional view of the stud (140) of the present invention penetrating through the structure (200) with a limit stud bolt head at the other end

FIG. 13 is a functional view of the present invention showing both ends of the stud (140) installed with nuts (101)

### DESCRIPTION OF MAIN COMPONENT SYMBOLS

(100): Cover
(101): Nut
(102): Inner ring gear
(103): Sleeve
(111): Nut-driven ring body
(112): Inner thread
(114): Radial locking structure
(115): Fix screw
(121): Sun gear cylinder
(122): Cylindrical gear
(123): Polyhedral prismatic structure
(123′): Sleeve with inner polygonal hole
(124): Polyhedral cylinder
(124′): Inner polygonal hole
(131): Planetary gear cylinder
(132): Planetary gear structure
(140): Stud
(141): Inner polygonal hole
(141′): Polyhedral cylinder
(142): Thread
(200): Structure
(300): Fixed element

### DETAILED DESCRIPTION OF THE PREFERRED EMBODIMENTS

The traditional gear-driven screw and nut set installs the outer ring gear on the nut, and installs the planetary gear on the bolt. The screw and nut set must be installed in the planetary gear set structure one by one which entails a relatively high production cost. The present invention of a planetary gear-driven magnification driving tool relies on randomly attachable and removable planetary gear-driven magnification driving tools to lock, adjust, and disassemble applied mechanism with screw structure such as screw locking device, screw adjusting device, and individual screw and nut set that do not need the installation of outer ring gear and planetary gear while reducing the installation cost for over a pair of such mechanisms.

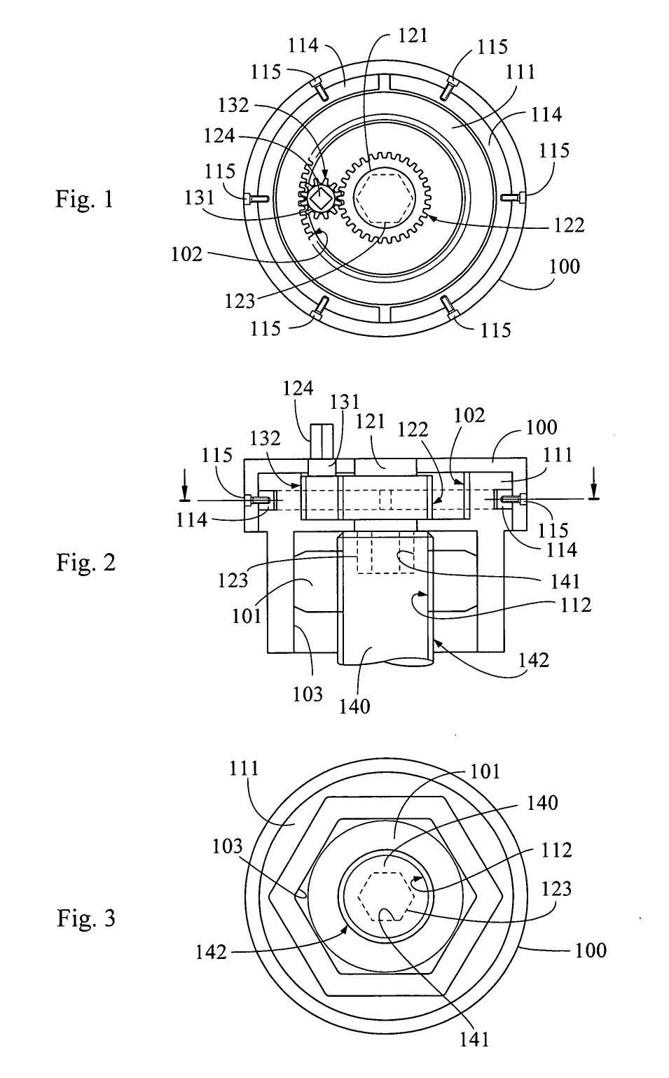

FIG. 1 is the top cross-sectional view of the present invention.

FIG. 2 is a cross-sectional view of the present invention FIG. 3 is a bottom view of the present invention.

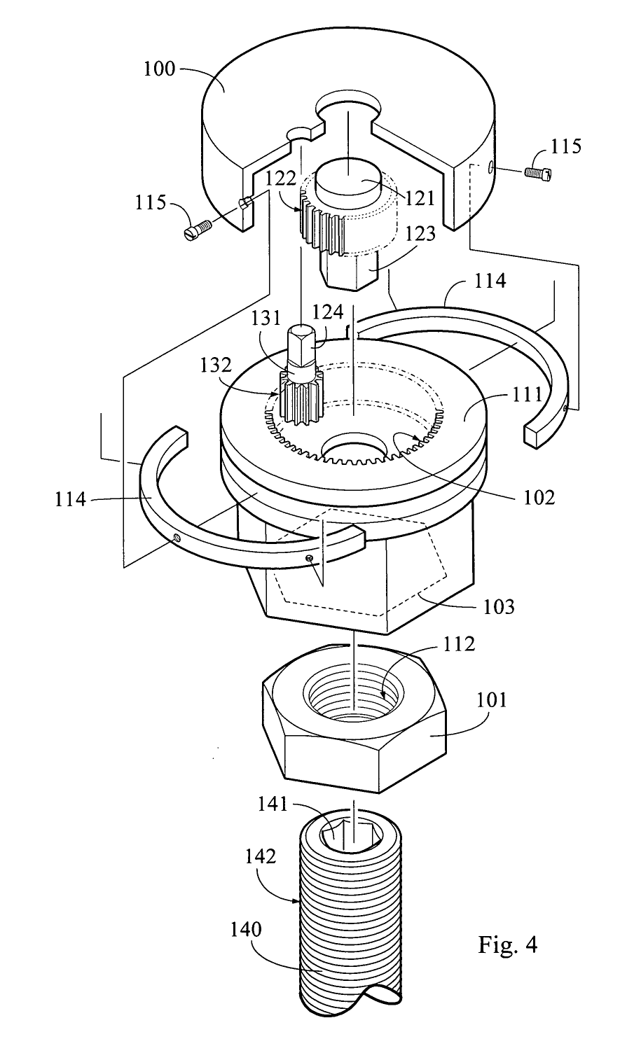

FIG. 4 is a dimensional exploded view of the present invention.

As shown in FIG. 1 to FIG. 4, the present invention drives the following screw and nut devices including:
Nut (101): A structure with polygonal exterior and inner thread (112) on inner part for fastening on the thread (142) of the stud (140);
Stud (140): Includes threads (142) while the stud head includes inner polygonal hole (141) or it assumes the form of a polyhedral cylinder (141′);

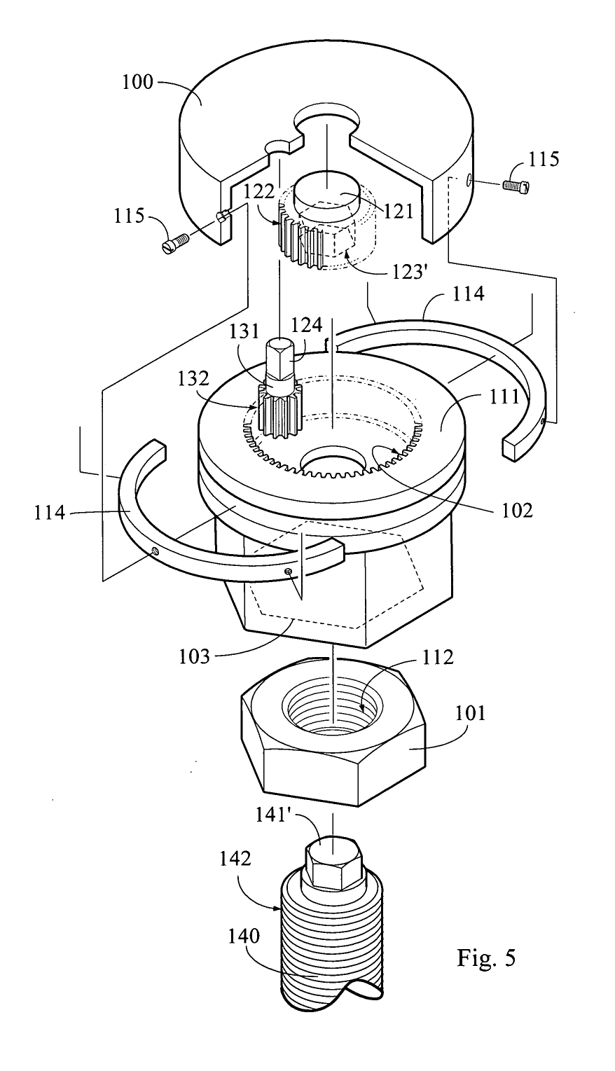

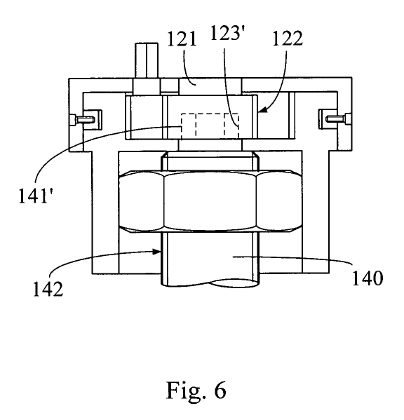

The aforementioned inner polygonal hole (141) on the stud (140) is optionally replaced by the polyhedral cylinder (141′) as shown in the dimensional view in FIG. 5 wherein the polyhedral cylinder (141′) replaces the inner polygonal hole (141) in FIG. 1 to FIG. 4. When the polyhedral cylinder (141′) is chosen to be installed, the polyhedral prismatic structure (123) coupled with the polyhedral cylinder (141′) will be transformed into a sleeve with inner polygonal hole (123′) in order to fit into and drive the polyhedral cylinder (141′). FIG. 6 is a cross-sectional view of the FIG. 5.

The main components of the planetary gear-driven magnification driving tool include:
Cover (100): A bottle cap-shape locking structure (114) that axially or radially combines with the upper outer ring of the nut-driven ring body (111) by means of a fix screw (115) in order to protect the planetary gear set. The cover (100) includes axial hole to support the sun gear cylinder (121) and through hole in the planetary gear cylinder (131) for the installation of the inner polygonal hole (124′) or the polyhedral cylinder (124) in order to couple with tools to drive the planetary gear cylinder (131).
Nut-driven ring body (111): A ring shape structure with its an integrated inner ring structure or installed with an inner ring gear (102) in an assembly manner. The lower section of the structure has sleeve (103) to couple with the exterior side of the nut (101) so that when the inner ring gear (102) is driven, nut (101) is loosen or locked by its rotating or counter-rotating motion.
Sun gear cylinder (121): The sun gear cylinder is a cylindrical structure with its integrated top section or formed into cylindrical gear (122) by assembly method. The upper section of the sun gear cylinder (121) couples with the axial hole of the cover (100) while its lower section is made in one piece or as an assembly, assuming a polyhedral prismatic structure (123) for coupling and movement with the inner polygonal hole (141) on the top side of the threaded (142) of the stud (140). Another way is to integrate into one body or form as an assembly the lower side of the aforementioned polyhedral prismatic structure (123) into a sleeve (123′) with inner polygonal hole to couple and move with the polyhedral cylinder (141′) on the top side of the threaded (142) of the stud (140).
Planetary gear (131): A planetary gear structure (132) is at the lower section of the planetary gear cylinder for coupling between the sun gear (122) of the sun gear cylinder (121) and the inner ring gear (102) of the nut-driven ring body (111) in order to form an interactive planetary gear set function. The upper section of the planetary gear cylinder (131) is equipped with a polyhedral cylinder (124) or inner polygonal hole (124′) for coupling randomly with external separated operational tools so that it could accept drive from coupled operational tools; or the operational tool is formed as an assembly with the planetary gear cylinder (131) or integrated as a single structure.

The above-mentioned nut-driven ring body (111), sun gear cylinder (121), planetary gear cylinder (131) and the tools formed for driving the planetary gear cylinder (131) form the planetary gear-driven magnification driving tool.

The aforementioned planetary gear-driven magnification driving tool, wherein the operational tool is the optional screwdriver. The inner polygonal hole (141) of stud (140) and/or the inner polygonal hole (124′) of the planetary gear cylinder (131) are converted into structures with slots to couple with the working end shape of the screw driver.

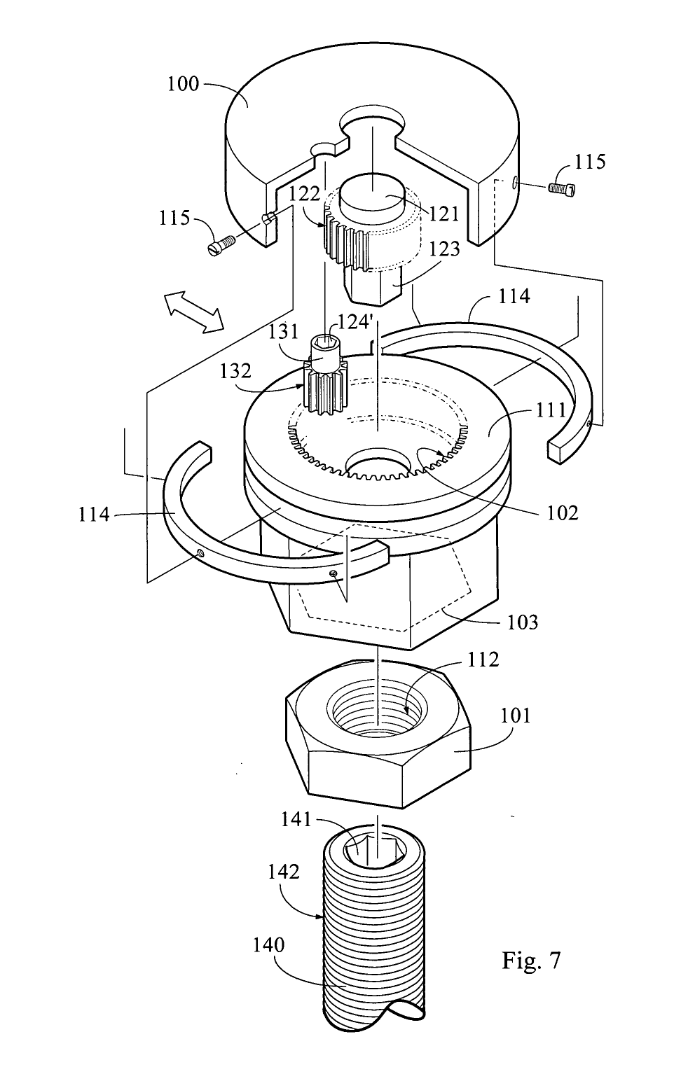

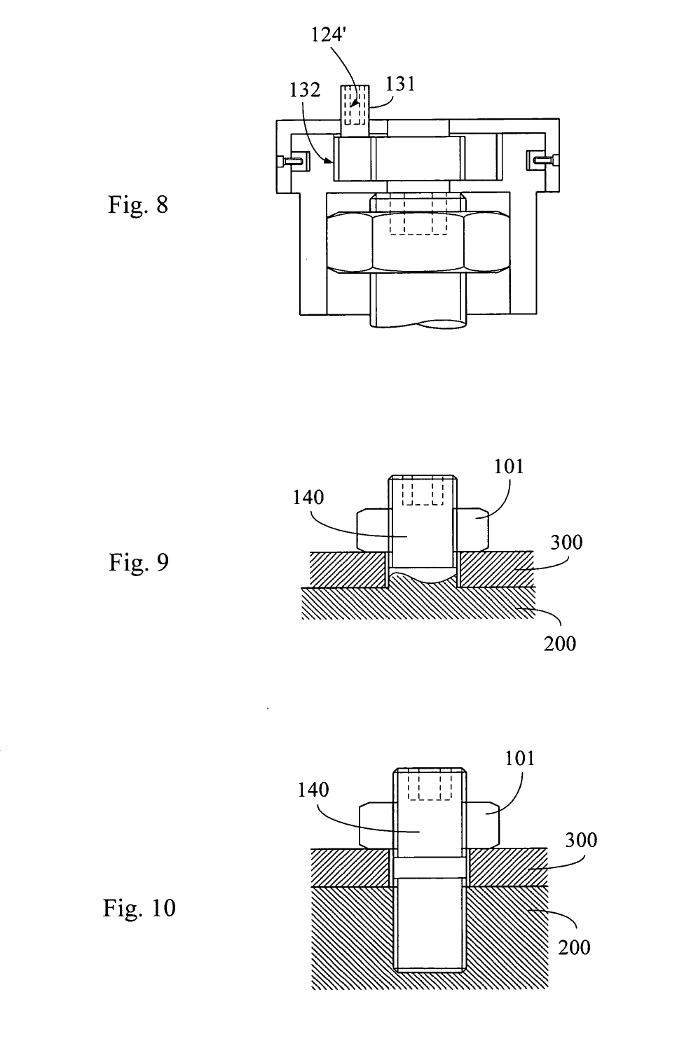

The aforementioned planetary gear-driven magnification driving tool, wherein the polyhedral cylinder (124) is optionally replaced by the inner polygonal hole (124′) as shown in the dimensional view in FIG. 7 wherein the inner polygonal hole (124′) replaces the polyhedral cylinder (124) in FIG. 1 to FIG. 4. When the inner polygonal hole (124′) is chosen to be installed, the formation will be as shown in the cross-sectional view of FIG. 7. FIG. 8 is a cross-sectional view of the FIG. 7.

The present invention of a sun gear coaxially driven screw and nut structure relies on manpower or fluid motor or mechanical power or electric motor to drive the operational tool which in turn drive the planetary gear cylinder (131); and to further drive the nut-driven ring body (111) with the inner ring gear (102). According to the speed reduction multiples of the planetary gear set, a magnification effect is produced to drive the nut (101) for locking on or loosening from the thread (142) of the stud (140) head.

Anti-vibration padding ring or gasket is optionally installed in the space between the drivable nut (101) and the stud (140) of the planetary gear-driven magnification driving tool or the nut is directly screwed on the thread (142) of the stud (140). The bottom end of the stud (140) serves as:

1) The stud (140) is welded on the structure (200) and the nut (101) is screwed on the stud (140) to lock or release the fixed element (300). FIG. 9 is a functional view of the present invention showing the driven stud (140) being welded on the structure (200); or

2) The stud (140) is screwed into the screw hole of the structure (200) by means of the stud structure and the nut (101) is screwed on the stud (140) in order to lock or release the fixed element (300). FIG. 10 is a functional view of the present invention showing the stud (140) being screwed into the screw hole of the structure (200); or

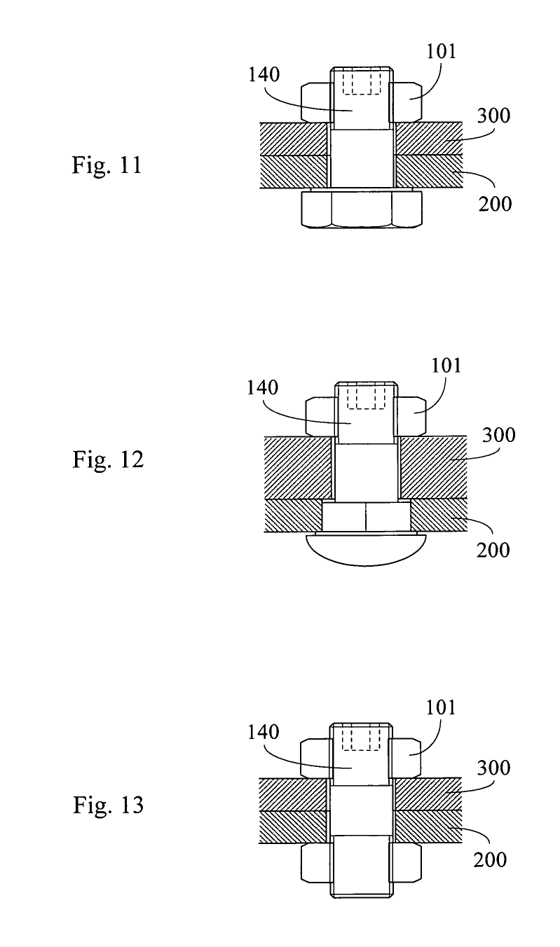

3) The stud (140) penetrates through the structure (200) with a nut at the other end joined to the structure (200); the nut (101) serves to screw onto the stud (140) in order to lock or release the fixed element (300); FIG. 11 is a functional view of the present invention showing the stud (140) penetrating the structure with the other end installed with a nut; or

4) The stud (140) penetrates through the structure (200) with a limit stud bolt head at the other end joined to the structure (200); the nut (101) serves to screw on the stud (140) in order to lock or release the fixed element (300). FIG. 12 is a functional view of the present invention showing the stud (140) penetrating through the structure (200) with a limit stud bolt head at the other end; or

5) The stud (140) penetrates through the structure (200) and the fixed element (300), and nuts (101) are screwed on both ends of the stud (140) in order to lock or release the fixed element (300). FIG. 13 is the functional view of the present invention showing both ends of the stud (140) installed with nuts (101);

The drive operational tool of planetary gear cylinder (131) employs one or more driving method of operational drive on the planetary gear cylinder (131) and/or stud (140) including:

1) one directional or reverse rotary drive;

2) reciprocating type one-way drive in which one driving direction produces driving effect while the other does not produce driving effect;

3) reciprocating type one-way drive in which one driving direction is chosen to produce driving effect while the other direction does not produce driving effect.

Aside from the protruding polyhedral cylinder (124) or the inner polygonal hole (124′) of the planetary gear cylinder (131); and/or the protruding polyhedral cylinder (141′) or the inner polygonal hole (141) of the stud (140) head, the kinds of planetary gear-driven magnification driving tool are many. The following are merely some of the several modes which are not to be used as restrictions. Coupling modes are formed by one or more of the following:

1) The planetary gear cylinder (131) can randomly couple with driving tools with T-type or L-type handles

2) The planetary gear cylinder and the T-type or L-type handle driving tool assume an integrated structure or an assembled structure

3) The randomly coupling driving tools of the planetary gear cylinder (131), or the assembly type or integrated type driving tools including the T-type or L-type handles possess articulating structure with foldable or universal adjusting angles;

4) The planetary gear cylinder (131) has inner polygonal hole (134) to accept drive modes of relatively coupleable driving tools including pulling by pulling tools or drive from rotary drive tools;

5) The planetary gear cylinder has protruding polyhedrons to accept driving modes of relatively coupling driving tools including drive by pulling tools or drive from rotary driving tools.

Aside from using various kinds of driving tools such as socket wrench, open wrench, closed wrench polygonal wrench or screwdrivers, the driving tool provided by the planetary gear-driven magnification driving tools for driving the planetary gear cylinder (131) and/or the stud (140) further include one or more of the following functional devices such as; 1) functional devices with torque limit; 2) functional devices which can adjust and set the required torque limit; 3) functional device with drive torque analog or digital display; 4) functional device that display drive torque with sound or voice; 5) functional device that displays drive torque with lamps.

1. A planetary gear-driven magnification driving tool relies on randomly attachable and removable planetary gear-driven magnification driving tools to lock, adjust, and disassemble applied mechanism with screw structure such as screw locking device, screw adjusting device, and individual screw and nut set that do not need the installation of outer ring gear and planetary gear;
the main components of the planetary gear-driven magnification driving tool includes:
Cover (100): A bottle cap-shape locking structure (114) that axially or radially combines with the upper outer ring of the nut-driven ring body (111) by means of a fix screw (115) in order to protect the planetary gear set; the cover (100) includes axial hole to support the sun gear cylinder (121) and through hole in the planetary gear cylinder (131) for the installation of the inner polygonal hole (124′) or the polyhedral cylinder (124) in order to couple with tools to drive the planetary gear cylinder (131);
Nut-driven ring body (111): A ring shape structure with its an integrated inner ring structure or installed with an inner ring gear (102) in an assembly manner; the lower section of the structure has sleeve (103) to couple with the exterior side of the nut (101) so that when the inner ring gear (102) is driven, nut (101) is loosen or locked by its rotating or counter-rotating motion;
Sun gear cylinder (121): The sun gear cylinder is a cylindrical structure with its integrated top section or formed into cylindrical gear (122) by assembly method; the upper section of the sun gear cylinder (121) couples with the axial hole of the cover (100) while its lower section is made in one piece or as an assembly, assuming a polyhedral prismatic structure (123) for coupling and movement with the inner polygonal hole (141) on the top side of the threaded (142) of the stud (140); another way is to integrate into one body or form as an assembly the lower side of the aforementioned polyhedral prismatic structure (123) into a sleeve (123′) with inner polygonal hole to couple and move with the polyhedral cylinder (141′) on the top side of the threaded (142) of the stud (140);
Planetary gear (131): A planetary gear structure (132) is at the lower section of the planetary gear cylinder for coupling between the sun gear (122) of the sun gear cylinder (121) and the inner ring gear (102) of the nut-driven ring body (111) in order to form an interactive planetary gear set function; the upper section of the planetary gear cylinder (131) is equipped with a polyhedral cylinder (124) or inner polygonal hole (124′) for coupling randomly with external separated operational tools so that it could accept drive from coupled operational tools; the aforementioned installation is comprised of one or more planetary gear stud (131) and planetary gear structure (132); and
the above-mentioned nut-driven ring body (111), sun gear cylinder (121), planetary gear cylinder (131) and the tools formed for driving the planetary gear cylinder (131) form the planetary gear-driven magnification driving tool.

2. A planetary gear-driven magnification driving tool as claimed in claim 1, wherein the operational tool is formed as an assembly with the planetary gear cylinder (131) or integrated as a single structure.

3. A planetary gear-driven magnification driving tool as claimed in claim 1, wherein the operational tool is the optional screwdriver; the inner polygonal hole (141) of stud (140) and/or the inner polygonal hole (124′) of the planetary gear cylinder (131) are converted into structures with slots to couple with the working end shape of the screw driver.

4. A planetary gear-driven magnification driving tool as claimed in claim 1 relies on manpower or fluid motor or mechanical power or electric motor to drive the operational tool which in turn drive the planetary gear cylinder (131); and to further drive the nut-driven ring body (111) with the inner ring gear (102); according to the speed reduction multiples of the planetary gear set, a magnification effect is produced to drive the nut (101) for locking on or loosening from the thread (142) of the stud (140) head.

5. A stud structure driven by the planetary gear-driven magnification driving tool as claimed in claim 1, wherein the bottom end of the stud (140) is welded on the structure (200) and the nut (101) is screwed on the stud (140) to lock or release the fixed element (300), its characteristics is that the stud is facing towards the rear end of the tool, and it contains an inner polygonal hole or polyhedral.

6. A stud structure driven by the planetary gear-driven magnification driving tool as claimed in claim 1, wherein the bottom end of the stud (140) is screwed into the screw hole of the structure (200) by means of the stud structure and the nut (101) is screwed on the stud (140) in order to lock or release the fixed element (300), its characteristics is that the stud is facing towards the rear end of the tool, and it contains an inner polygonal hole or polyhedral.

7. A stud structure driven by the planetary gear-driven magnification driving tool as claimed in claim 1, wherein the bottom end of the stud (140) penetrates through the structure (200) with a nut at the other end joined to the structure (200); the nut (101) serves to screw onto the stud (140) in order to lock or release the fixed element (300), its characteristics is that the stud is facing towards the rear end of the tool, and it contains an inner polygonal hole or polyhedral.

8. A stud structure driven by the planetary gear-driven magnification driving tool as claimed in claim 1, wherein the bottom end of the stud (140) penetrates through the structure (200) with a limit stud bolt head at the other end joined to the structure (200); the nut (101) serves to screw on the stud (140) in order to lock or release the fixed element (300), its characteristics is that the stud is facing towards the rear end of the tool, and it contains an inner polygonal hole or polyhedral.

9. A stud structure driven by the planetary gear-driven magnification driving tool as claimed in claim 1, wherein the bottom end of the stud (140) penetrates through the structure (200) and the fixed element (300), and nuts (101) are screwed on both ends of the stud (140) in order to lock or release the fixed element (300), its characteristics is that the stud is facing towards the rear end of the tool, and it contains an inner polygonal hole or polyhedral.

10. A planetary gear-driven magnification driving tool as claimed in claim 1 can drive the following screw and nut devices including:
Nut (101): A structure with polygonal exterior and inner thread (112) on inner part for fastening on the thread (142) of the stud (140);
Stud (140): Includes threads (142) while the stud head includes inner polygonal hole (141) or it assumes the form of a polyhedral cylinder (141′).

11. A planetary gear-driven magnification driving tool as claimed in claim 10, wherein the inner polygonal hole (141) on the stud (140) is optionally replaced by the polyhedral cylinder (141′); when the polyhedral cylinder (141′) is chosen to be installed, the polyhedral prismatic structure (123) coupled with the polyhedral cylinder (141′) will be transformed into a sleeve with inner polygonal hole (123′) in order to fit into and drive the polyhedral cylinder (141′).
